(19) United States
(12) Patent Application Publication
(10) Pub. No.: US 2011/0091217 A1
(43) Pub. Date: Apr. 21, 2011

(54) APPARATUS AND METHOD FOR TRANSPORTING MULTIPLE RADIO SIGNALS OVER OPTICAL FIBER

(75) Inventors: Chin-Pang Liu, London (GB); Alwyn John Seeds, London (GB)

(73) Assignee: UCL BUSINESS PLC, London (GB)

(21) Appl. No.: 12/918,545

(22) PCT Filed: Feb. 18, 2009
(86) PCT No.: PCT/GB2009/000433

§ 371 Date: Nov. 24, 2010

(30) Foreign Application Priority Data
Feb. 20, 2008 (GB) 0803093.4

(51) Int. Cl. H04B 10/12

(52) U.S. Cl. 398/116

(57) ABSTRACT

A method and apparatus for transporting three or more radio signals of the same frequency, such as multiple input multiple output (MIMO) radio signals, over optical fiber on a single optical carrier using a phase quadrature double sideband frequency translation technique is disclosed.

The present invention relates to the field of telecommunications and more particularly, to transporting three or more radio signals of the same frequency, such as multiple input, multiple output (MIMO) radio signals, over optical fiber.

A radio signal is defined as a signal whose carrier frequency corresponds to the part of the electromagnetic spectrum in the frequency range between 3 kHz and 300 GHz. This encompasses the part of the communications spectrum that may also be referred to as microwave. Radio signals of the same frequency concerned are to be understood to have the same carrier frequency. Baseband signal has nonzero spectral amplitude between 0 Hz (DC) and an upper frequency which is dependent on the modulation rate. Optical signal is to be understood to be any electromagnetic radiation in the visible light and infrared regions with the wavelength range between 380 nm and 3000 nm which corresponds to the frequency range between 789 THz and 100 THz.

The rapid rise in information and telecommunication services has resulted in the need for ever more efficient and higher capacity wireless services to provide very high speed wireless multimedia communication services. This is being achieved through the use of a combination of optical communication and wireless communication technologies where a wired communication technology is combined with a wireless communication technology to provide a high speed transmission system along with a mobile wireless technology—such a technology being called Radio over Fiber (ROF).

Such an ROF technology uses an optical link apparatus and a radio link apparatus as the basic components. The optical link apparatus modulates a baseband transmission signal into a radio frequency band signal, converts the radio frequency band signal into an optical signal, and then transmits the optical signal through an optical fiber. This optical signal is then converted back into the electrical domain and the wireless link apparatus wirelessly carries a signal which has been received through the optical fiber.

In an environment in which various wireless services for voice, broadcasting, data, etc., are provided, it is inefficient to construct a remote antenna link for every type of service. Hence methods for combining multiple signals and transmitting them over a single optical fiber are of significant value and the focus of research.

The distribution of radio signals over optical fibers reduces the complexity of remote antenna units (AUs) and helps centralise communication equipment in the central offices which facilitates routine system maintenance and reduces costs. Compared to the signal distribution using conventional coaxial cables, the low transmission loss characteristic of optical fibers extends the distance the remote antenna units can be located from the central offices. Another advantage of using optical fibers compared to using conventional coaxial cables is the much wider transmission bandwidth which allows a combination of cellular, wireless local area network (WLAN) and other wireless service signals at different frequencies to be distributed together over a single optical fiber. Commercial radio over fiber (ROF) products are already on sale for carrying a multitude of existing wireless services, such as the GSM, UMTS and IEEE 802.11b/g WLAN, using optical fibers.

Considering the wireless network services continued demand for higher data transmission rates without a corresponding increase in the allocated radio channel bandwidth has led to the development of the Multiple Input Multiple Output (MIMO) system. MIMO is a multi-antenna radio transmission technique using multiple antennas for transmitting and multiple antennas for receiving. Compared to the Single Input Single Output (SISO) technique, MIMO has two major performance enhancements.

Firstly, the use of multiple antennas in a MIMO system increases the transmission range and/or improves the radio link reliability through the well-known spatial diversity technique.

Secondly, MIMO systems can deliver higher data transmission rates over the airwave than the SISO counterparts for the same channel bandwidth. This transmission rate enhancement is achieved using a technique known as spatial multiplexing. Spatial multiplexing can be compared to solving a set of simultaneous equations where the transmitted radio signals from different transmitting antennas are analogous to the independent variables, and the received radio signals by different receiving antennas are analogous to the dependent variables. Once the different radio transmission path characteristics between each of the transmitting antennas and each of the receiving antennas have been established, the coefficients describing the set of simultaneous equations can be determined. Each of the received radio signals is dependent on all of the different transmitted radio signals. With the received radio signals and the coefficients describing the different radio path characteristics, each of the different transmitted radio signals can then be obtained mathematically, analogous to solving for the independent variables of a set of simultaneous equations. As a result all the different transmitted radio signals, despite having the same frequency occupying the same channel bandwidth, can be radiated to and received by the receiver individually with a higher aggregate transmission rate compared to an SISO system, as if a number of parallel radio channels existed between the transmitter and the receiver.

New and emerging wireless standards increasingly employ MIMO for greater data throughputs as well as for improving transmission range/reliability. Examples of wireless standards employing MIMO include the IEEE 802.11n WLAN, the IEEE 802.16e WiMAX and all future 4^{th} generation (4G) cellular systems.

While optical fiber is well suited for carrying radio signals of different frequencies, it is not straightforward to use the same radio over fiber technique for transmitting a group of signals of the same frequency, such as the MIMO signals feeding multiple antennas, over an optical fiber.

This difficulty arises because to transmit multiple radio signals, they have to be combined first in, for example, a power combiner prior to transmission over an optical fiber. If the radio signals involved have different frequencies, they can be easily separated and recovered using simple electrical filters after transmission over fiber. If, on the other hand, the radio signals are of the same frequency, it will be impossible to separate and recover the individual radio signals without any form of signal processing or multiplexing/demultiplexing technique before and after transmission over an optical fiber.

A conventional solution for tackling this problem is to employ as many individual optical fibers as there are radio signals. However, it would mean substantially increasing the cost of constructing such MIMO radio over fiber system as each transmitting antenna would need its own optical fiber and associated components.

A number of techniques have been reported by others for transporting radio signals having the same frequency over a single optical fiber.

With wavelength division multiplexing (WDM), each of the radio signals to be transmitted is modulated onto and carried by one optical carrier of a different wavelength. Optical wavelength dependent filters are used to multiplex and demultiplex the optical carriers of different wavelengths before and after transmission over the fiber, respectively.

With sub-carrier multiplexing (SCM), also referred to as frequency division multiplexing (FDM), the radio signals are first frequency shifted into different frequency bands using electrical mixers and local oscillator sources so that they can be modulated onto and carried by a single optical carrier for transmission over an optical fiber. After the fiber, the frequency shifted radio signals are separated using electrical filters and then frequency shifted again to their original frequency band.

Allert van Zelst in US Patent Application Publication US 20040017785A1 described, in very broad terms, using the well-known WDM and FDM techniques a method for transporting MIMO radio signals over an optical fiber.

Ichiro Seto et al. in “Optical Subcarrier Multiplexing Transmission for Base Station With Adaptive Array Antenna”, IEEE Transactions On Microwave Theory And Techniques, Vol. 49, No. 10, pp. 2036-2041, October 2001, proposed transporting a multitude of radio signals destined for a group of adaptive array antennas over a single optical fiber using SCM. Adaptive array antennas require accurate and stable relative phase relationship between the radio signals radiated by individual antennas. Since all the radio signals are transported over a single optical fiber, any disturbance to the fiber resulting in fluctuating path length will affect all the signals equally but their relative phase relationship remains unaffected. Although such an SCM technique has been proposed for carrying adaptive array antenna signals which are different between them only in the phase and amplitude but not the actual radio content, the same technique can be applied to carry MIMO radio signals.

P. Ritosa et al. in “Optically steerable antenna array for radio over fibre transmission”, Electronics Letters, Vol. 41, No. 16, pp. 47-48, 4 Aug. 2005, reported transmitting the received radio signals at 2.1 GHz from the three elements of a smart antenna array over an optical fiber using WDM. The relative signal phase relationship was controlled by the choice of the laser wavelengths since the signal transmission speed over fiber is wavelength dependent. The relative signal amplitude was adjusted using external Mach-Zehnder modulators. Although the system was set up simply to demonstrate its ability to create different radiation patterns by varying the relative signal phase amplitude, it can easily be adopted for carrying MIMO radio signals using the same WDM technique.

There are a number of drawbacks associated with the WDM and SCM techniques for transporting MIMO signals over a single optical fiber.

If WDM is used, then as many optical sources of different wavelengths and the corresponding photodetectors as there are radio signals to be transported will be required since each signal will need its own optoelectronic components for the electrical-to-optical and optical-to-electrical conversion processes. Since many more components are required, the cost of constructing a WDM based ROF system for MIMO will increase substantially and almost linearly with the number of antennas.

If SCM is used, all but one of the MIMO radio signals need to be initially frequency translated to different frequency bands before fiber transmission, and subsequently frequency translated back to the original frequency band afterwards. Therefore, if there are a total of n MIMO radio signals to be transported, n−1 different LO sources are required. Moreover, it is common in SCM to frequency translate those MEMO signals to an intermediate frequency (IF) band which is substantially different from the original radio frequency, e.g. from 2.4 GHz to 100 MHz, therefore separate electrical amplifiers covering different frequency bands are required for the frequency translated and non-translated MIMO signals.

It is an object of the prevent invention to alleviate, at least partially, any of the above problems.

The present invention provides an apparatus for transporting three or more radio signals of the same frequency over at least one optical fiber, on a single optical carrier, the apparatus comprising:
a first frequency translator arranged to frequency translate a first radio signal to a lower and an upper sideband by mixing the first radio signal with an in-phase version of a first LO signal, and arranged to frequency translate a second radio signal to the same lower and the same upper sideband by mixing the second radio signal with a quadrature-phase version of the same LO signal;
wherein, when the number of radio signals is greater than three, the apparatus comprises a further respective frequency translator for each further pair of signals, arranged to operate in the same way as the first frequency translator to frequency translate each respective pair of radio signals to a different respective pair of lower and upper sidebands around the original radio signal frequency, but using a different LO frequency signal for each said further pair of the radio signals;
wherein, when the total number of radio signals is an odd number, the apparatus is arranged such that the last single radio signal that is not part of any of the radio signal pairs is not frequency translated;
one or more combiners arranged to combine together all resulting pairs of lower and upper sidebands and said last single radio signal, when present, into a single electrical signal;
an optical source arranged to generate an optical carrier signal modulatable by said single electrical signal;
at least one optical fiber arranged to transport the modulated optical carrier signal generated by the optical source;
a photodetection unit arranged to detect the optical signal after transmission over the at least one optical fiber and produce a corresponding received electrical signal;
wherein, when the total number of radio signals is an odd number, the apparatus comprises at least one filter arranged to separate and recover the last single radio signal from the other lower and upper sidebands in the received electrical signal;
first and second mixers arranged to mix the lower and upper sidebands, generated by the first frequency translator, contained in the received electrical signal with the in-phase and quadrature-phase versions of an LO signal having the same LO frequency as used in the first frequency translator to recover the first and second radio signals at their original radio frequency; and
wherein, when the number of radio signals is greater than three, the apparatus comprises further mixers, arranged to operate in the same way as the first and second mixers to recover each other pair of radio signals at the original radio frequency by mixing the respective lower and upper sidebands generated from each respective pair of signals, contained in the received electrical signal, with the in-phase and quadrature-phase versions of a respective LO signal having respective LO frequency as used in the respective further frequency translator.

The invention also provides a method for transporting three or more radio signals of the same frequency over at least one optical fiber, on a single optical carrier, the method comprising:
frequency translating a first radio signal to a lower and an upper sideband by mixing the first radio signal with an in-phase version of an LO signal, and frequency translating a second radio signal to the same lower and the same upper sideband by mixing the second radio signal with a quadrature-phase version of the same LO signal, with these two resulting pairs of lower and upper sidebands subsequently combined together;
wherein, when the number of radio signals is greater than three, frequency translating each further pair of radio signals, in the same way as the first and second radio signals, to a different respective pair of lower and upper sidebands around the original radio signal frequency, using a different LO frequency signal for each further pair of radio signals;
wherein, when the total number of radio signals is an odd number, the last single radio signal that is not part of any of the radio signal pairs is not frequency translated;
combining together all resulting pairs of lower and upper sidebands and said last single radio signal, when present, into a single electrical signal;
modulating an optical carrier signal using said single electrical signal;
transporting the modulated optical carrier signal over at least one optical fiber;
detecting the optical signal after transmission over the at least one optical fiber and producing a corresponding received electrical signal;
wherein, when the total number of radio signals is an odd number, separating and recovering the last single radio signal from the lower and upper sidebands in the received electrical signal by filtering;
recovering the first and second radio signals at their original radio frequency by mixing the lower and upper sidebands, generated by the first frequency translating step, contained in the received electrical signal with the in-phase and quadrature-phase versions of an LO signal having the same LO frequency as used in the first frequency translating step; and
wherein, when the number of radio signals is greater than three, recovering each other pair of radio signals at the original radio frequency by mixing the respective lower and upper sidebands generated from each respective pair of signals, contained in the received electrical signal, with the in-phase and quadrature-phase versions of a respective LO signal having respective LO frequency as used in the respective frequency translation.

Accordingly the invention enables the transport of three or more radio signals of the same frequency, over an optical fiber or fibers on a single optical carrier. Embodiments of the invention require fewer local oscillator sources or frequencies compared to those employing SCM and fewer optical sources of different wavelengths compared to those employing WDM, and therefore can be substantially cheaper to construct compared to other existing alternatives.

In one embodiment of the invention two MIMO radio signals at a time are processed using one low-frequency local oscillator (LO) source. In the transmitter the first of the two MIMO radio signals is frequency translated to an upper and a lower sideband by mixing with the in-phase version of the LO source while the other MIMO radio signal, being the second of the two, is frequency translated to the same upper and lower sidebands by mixing with the quadrature-phase version of the same LO source. As a consequence, each of the two MIMO radio signals now occupies an upper and a lower sideband around its original radio frequency at an offset equal to the LO source frequency. The two sets of upper and lower sidebands are combined, forming a composite upper and a composite lower sideband. Since the original MIMO radio signal frequency band between the composite upper and the lower sidebands is not used by these two MIMO radio signals at this point after frequency translation, it can be occupied by and used for transmission of a third MIMO radio signal without frequency translation. The composite upper sideband, the composite lower sideband and the third MIMO radio signal are then combined using an electrical diplexer/duplexer or power combiner or other components performing similar function before electrical-optical conversion into an optical signal and transmission over an optical fiber.

After transmission over fiber and optical-electrical conversion back to the electrical domain in the receiver, the third MIMO radio signal is separated from the composite upper and lower sidebands using an electrical diplexer or bandpass filter or other components performing similar function. The composite upper and lower sidebands are divided into two equal parts using a power divider. To recover the first MIMO radio signal and return it to the original frequency, one part of the composite upper and lower sidebands is mixed with the in-phase version of an LO source whose frequency is the same as the LO source in the transmitter. To recover the second MIMO radio signal and return it to the original frequency, the other part of the composite upper and lower sidebands is mixed with the quadrature-phase version of the same LO. One advantageous feature of the invention is that it is not necessary to have a separate high frequency LO in the receiver. The LO signal generated by the LO in the transmitter can be sent over the same fiber to the receiver for the mixing processes. Bandpass filtering will be required to remove unwanted mixed products.

For transporting three MIMO radio signals, the present invention requires only one LO source or frequency. In comparison, a system employing SCM will require at least two LO sources or frequencies in order to frequency translate two of the three MIMO radio signals from their original frequency before transmission over an optical fiber.

The present invention can be adopted for carrying a greater number of MIMO radio signals requiring a smaller number of LO sources or frequencies compared to systems employing SCM performing the same tasks. To transport four or five MIMO radio signals over an optical fiber, the present invention requires only two LO sources or frequencies. An SCM based system will require three and four LO sources or frequencies to transport four and five MIMO radio signals, respectively. Similarly systems employing WDM will require more optical sources of different wavelengths compared to the invention. Systems implemented with the present invention are therefore substantially cheaper to construct compared to other existing alternatives. This reduces the power burden of the system.

Embodiments of the invention will now be described, by way of example only, with reference to the accompanying drawings in which:

FIG. 1 shows mixing of the first MIMO radio signal with the in-phase LO signal to generate the resultant frequency translated lower and upper sidebands;

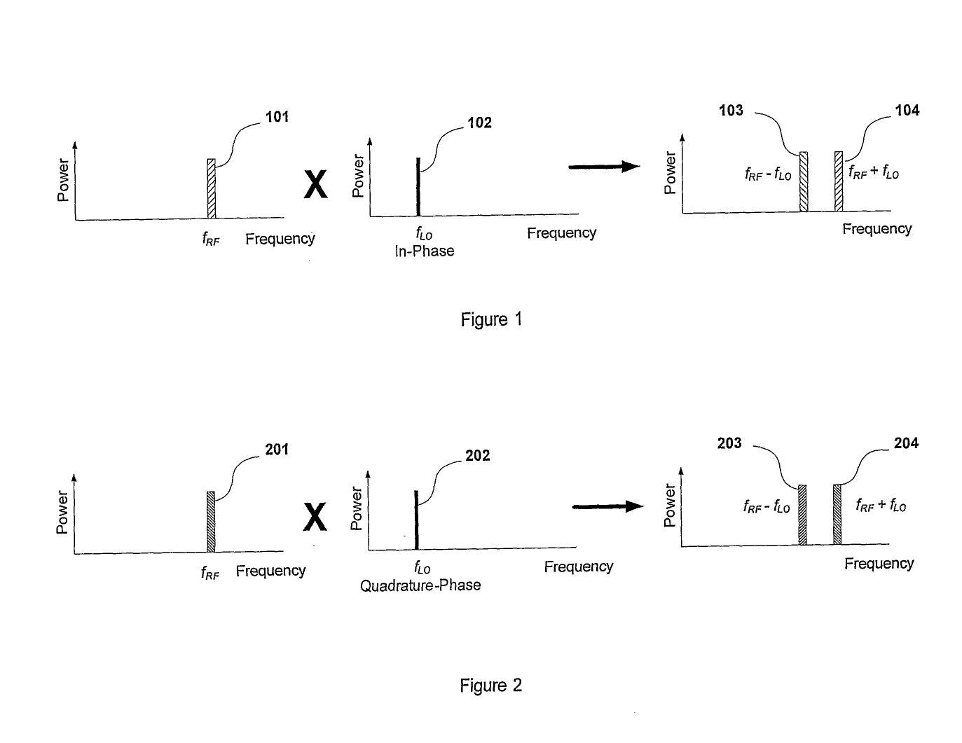

FIG. 2 shows mixing of the second MIMO radio signal with the quadrature-phase LO signal to generate the resultant frequency translated lower and upper sidebands;

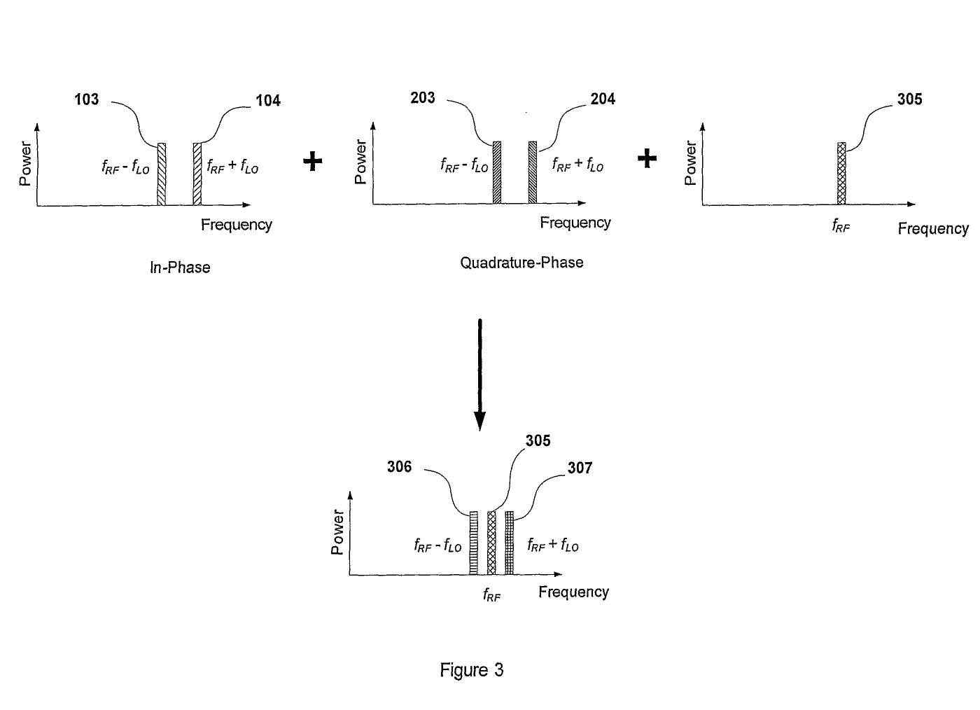

FIG. 3 illustrates the process of combining the third MIMO radio signal with the frequency translated lower and upper sidebands from the first MIMO radio signal and with the frequency translated lower and upper sidebands from the second MIMO radio signal;

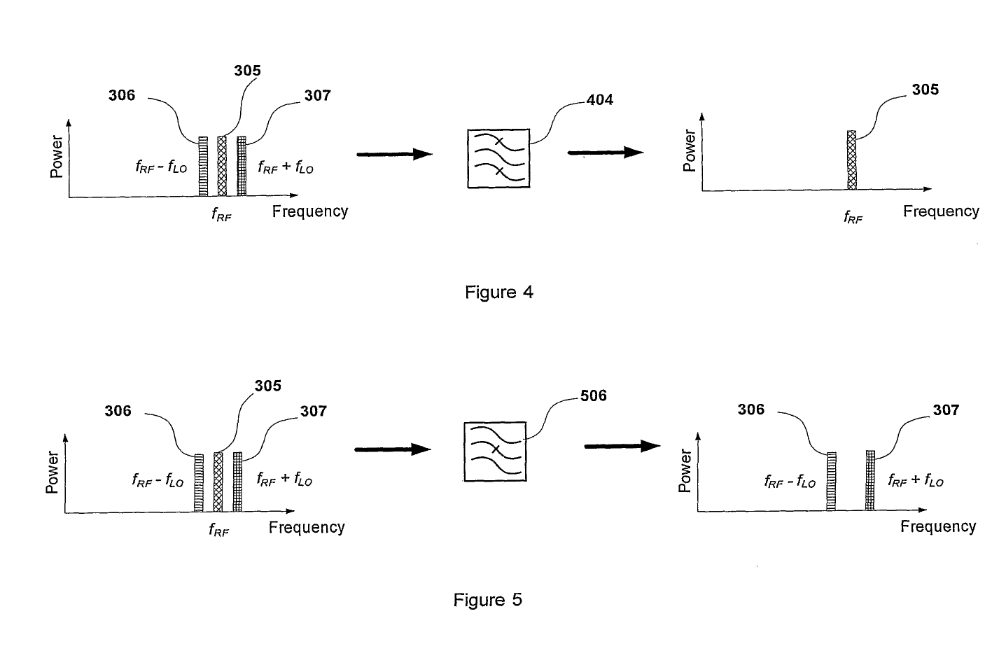

FIG. 4 illustrates separation of the third MIMO radio signal by bandpass filtering;

FIG. 5 illustrates separation of the composite lower and upper sidebands due to the first and second MIMO radio signals by bandstop filtering;

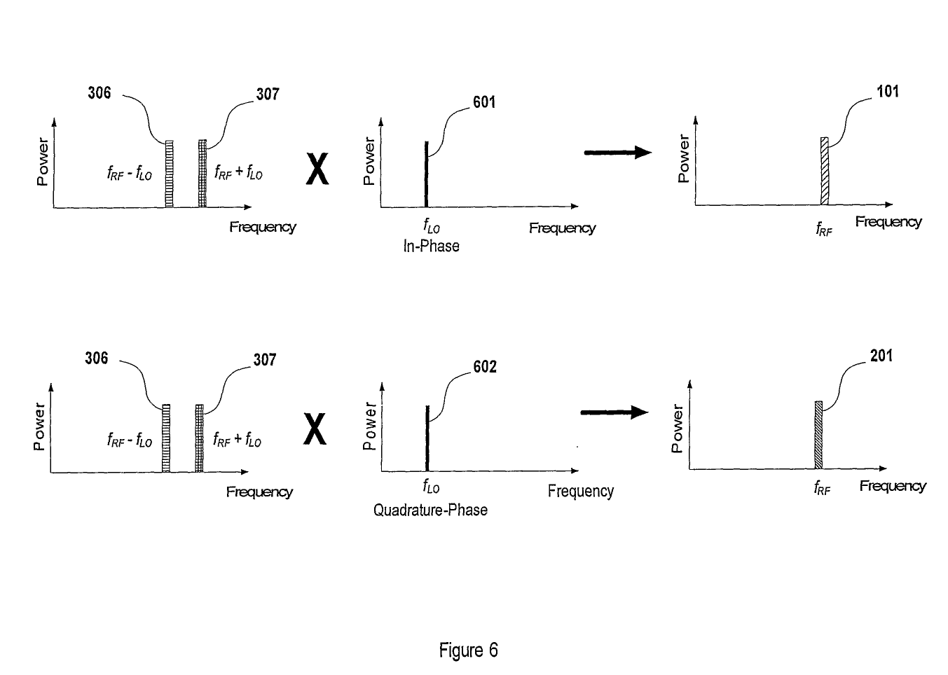

FIG. 6 shows recovery of the original first and second MIMO radio signals by mixing the composite lower and upper sidebands with the in-phase and quadrature-phase versions of the LO signal, respectively;

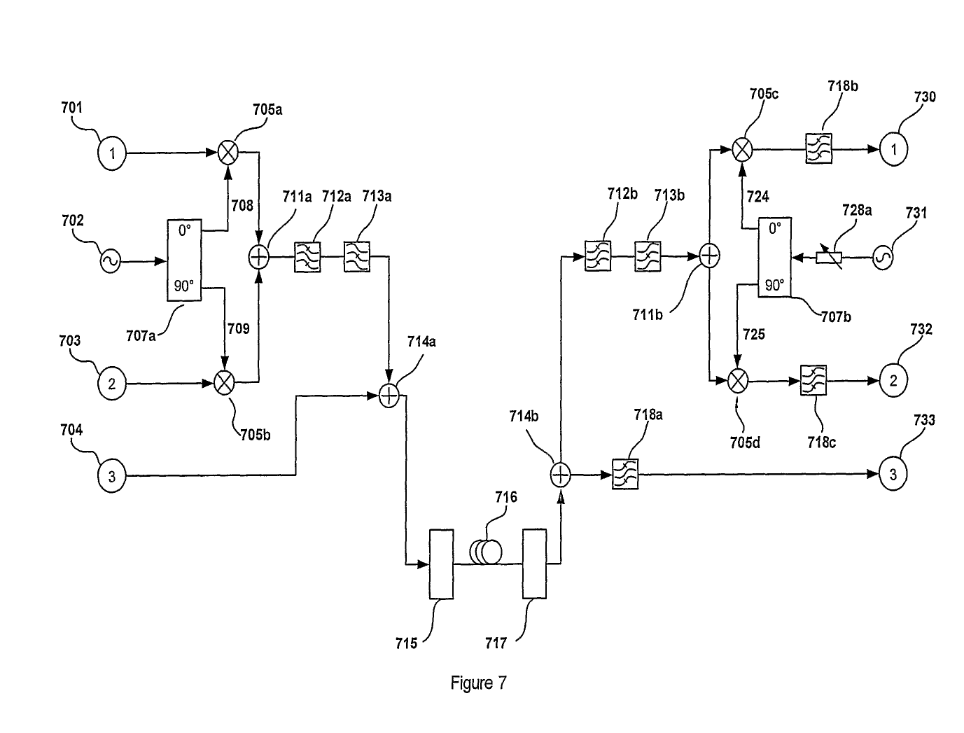

FIG. 7 is a schematic representation of an apparatus embodying the present invention for transporting three MIMO radio signals over optical fiber; and

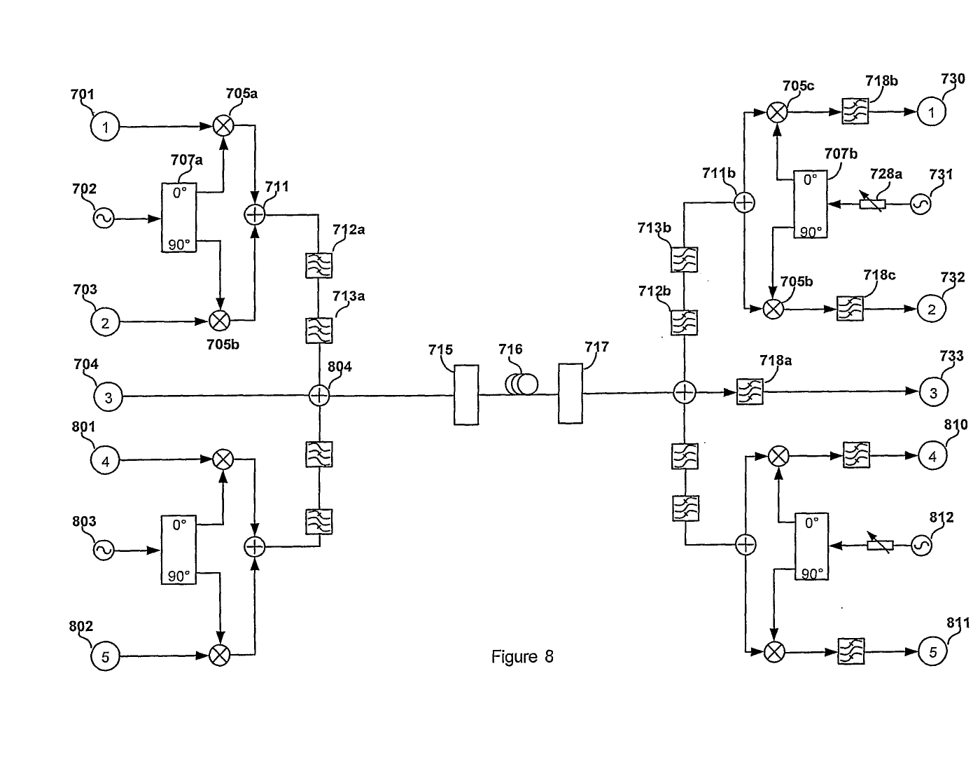

FIG. 8 is a schematic representation of an apparatus embodying the present invention for transporting five MIMO radio signals over optical fiber.

The invention can be understood by considering the following the mathematical basis and embodiments of the invention. In a first embodiment the radio signals to be transmitted over optical fiber are MIMO radio signals though it is understood that the invention applies to any radio signals of the same frequency.

FIG. 1 shows a first MIMO radio signal 101, with a radio frequency carrier of frequency f_{RF}, that can be represented by R(t)·cos(2πf_{RF}t+θ(t)) where R(t) and θ(t) are the amplitude and phase modulations as a function of time t on the radio frequency carrier of frequency f_{RF}. FIG. 2 shows a second MIMO radio signal 201, with a radio frequency carrier of frequency f_{RF}, that can be represented by S(t)·cos(2πf_{RF}t+φ(t)) where S(t) and φ(t) are the amplitude and phase modulations as a function of t on the radio frequency carrier of frequency f_{RF}.

The two MIMO radio signals 101, 201 occupy the same frequency band around f_{RF} which has the result that they cannot simply be combined together, transported over an optical fiber and separated again afterwards without signal processing being employed.

The transportation of a multiplicity of MIMO radio signals having the same frequency over an optical fiber is achieved by means of a novel phase quadrature double sideband frequency translation technique. Such a technique is employed and applied to two MIMO radio signals at a time by mixing the two signals with the in-phase and quadrature-phase outputs of a low-frequency LO source.

FIG. 1 shows a MIMO radio signal 101 of frequency f_{RF} being mixed with the in-phase output of an LO 102 that has a frequency of f_{LO}. This mixing results in a lower sideband 103 with frequency (f_{RF}−f_{LO}) and an upper sideband 104 with frequency (f_{RF}+f_{LO}). Mathematically, the mixing process of the first MIMO radio signal 101 with the in-phase output 102 of an LO source and the resulting mixed products 103, 104 can be described by

$$R ( t ) \cdot cos ( 2 π {f}_{RF} t + θ ( t ) ) \cdot cos ( 2 π {f}_{LO} t ) = \frac{1}{2} \cdot ( R ( t ) \cdot cos ( 2 π \cdot ( {f}_{RF} - {f}_{LO} ) \cdot t + θ ( t ) ) + R ( t ) \cdot cos ( 2 π \cdot ( {f}_{RF} + {f}_{LO} ) \cdot t + θ ( t ) ) )$$

Here cos(2πf_{LO}t) represents the in-phase output of an LO source 102 of frequency f_{LO}, R(t)·cos(2π·(f_{RF}−f_{LO})·t+θ(t)) represents the lower sideband 103 at frequency f_{RF}−f_{LO} and R(t)·cos(2π·(f_{RF}+f_{LO})·t+θ(t)) represents the upper sideband 104 at frequency f_{RF}+f_{LO} following the mixing process.

Similarly FIG. 2 shows another MIMO radio signal 201 of frequency f_{RF} being mixed with the quadrature-phase output of an LO 202 that has a frequency f_{LO}. This mixing results in a lower sideband 203 with frequency (f_{RF}−f_{LO}) and an upper sideband 204 with frequency (f_{RF}+f_{LO}). Mathematically, the mixing process of the second MIMO radio signal 201 with the quadrature-phase output 202 of an LO source and the resulting mixed products 203, 204 can be described by

$$S ( t ) \cdot cos ( 2 π {f}_{Rf} t + ϕ ( t ) ) \cdot sin ( 2 π {f}_{LO} t ) = \frac{1}{2} \cdot ( - S ( t ) \cdot sin ( 2 π \cdot ( {f}_{RF} - {f}_{LO} ) \cdot t + ϕ ( t ) ) + S ( t ) \cdot sin ( 2 π \cdot ( {f}_{RF} + {f}_{LO} ) \cdot t + ϕ ( t ) ) )$$

where sin(2πf_{LO}t) represents the quadrature-phase output of an LO source 202 which is at the same frequency f_{LO} as LO source 102 (in a physical implementation 102 and 202 are derived from a single LO source), −S(t)·sin(2π·(f_{RF}−f_{LO})·t+φ(t)) represents the lower sideband 203 at frequency f_{RF}−f_{LO} and S(t)·sin(2π·(f_{RF}+f_{LO})·t+φ(t)) represents the upper sideband 204 at frequency f_{RF}+f_{LO}.

Following the mixing processes, the original frequency band at f_{RF} is no longer occupied by either of the two MIMO signals since the in-phase frequency translated MIMO signal sidebands 103, 104 and the quadrature-phase frequency translated MIMO signal sidebands 203, 204 now occupy the two shared frequency bands at (f_{RF}−f_{LO}) and (f_{RF}+f_{LO}). The vacant frequency band at f_{RF} can now accommodate a third MIMO 305 signal without frequency translation. FIG. 3 shows the combining of a third MIMO signal 305 with the in-phase frequency translated MIMO signal sidebands 103, 104 and the quadrature-phase frequency translated MIMO signal sidebands 203, 204, resulting in a composite lower sideband signal 306, a composite upper sideband signal 307 and a single signal 305. The resultant signals are now suitable for transmission over fiber.

Following transmission over fiber, the original three MIMO signals need to be recovered and separated.

Firstly, the third MIMO signal 305 can be recovered by simply passing the resultant radio signals through a bandpass filter 404 around f_{RF} as shown in FIG. 4.

In a similar manner FIG. 5 shows the resultant radio signals being passed through a bandstop filter 506 around f_{RF} which removes signal 305 of frequency f_{RF} leaving one composite lower sideband signal 306 at frequency (f_{RF}−f_{LO}) and one composite upper sideband signal 307 at frequency (f_{RF}+f_{LO}) from which the original first and second MIMO signals are recovered. This recovery is achieved by first dividing the composite upper and lower sideband signals into two equal parts using a power divider and treating each part to recover one of the two original MIMO signals.

To recover one of the MIMO signals and return it to the original frequency, one part of the split composite upper and lower sideband signals is mixed with an in-phase LO signal 601 which is of the same frequency and phase as 102. Similarly the other MIMO signal is recovered by mixing the other part of the split composite upper and lower sideband signals with a quadrature-phase LO signal 602 which is also of the same frequency and phase as 202. FIG. 6 shows firstly one part of the composite upper sideband 307 and lower sideband 306 signals being mixed with the in-phase LO signal 601 resulting in the recovery of the original first MIMO signal 101 at f_{RF}. Secondly FIG. 6 shows the other part of the composite upper sideband 307 and lower sideband 306 signals being mixed with the quadrature-phase LO signal 602 resulting in the recovery of the original second MIMO signal 201 at f_{RF}.

Mathematically the recovery mixing process for the first MIMO radio signal is described by

$$[ \begin{matrix}\frac{1}{2} \cdot ( \begin{matrix}R ( t ) \cdot cos ( 2 π \cdot ( {f}_{RF} - {f}_{LO} ) \cdot t + θ ( t ) ) + \\ R ( t ) \cdot cos ( 2 π \cdot ( {f}_{RF} + {f}_{LO} ) \cdot t + θ ( t ) )\end{matrix} ) + \\ \frac{1}{2} \cdot ( \begin{matrix}- S ( t ) \cdot sin ( 2 π \cdot ( {f}_{RF} - {f}_{LO} ) \cdot t + ϕ ( t ) ) + \\ S ( t ) \cdot sin ( 2 π \cdot ( {f}_{RF} + {f}_{LO} ) \cdot t + ϕ ( t ) )\end{matrix} )\end{matrix} ] \cdot cos ( 2 π {f}_{LO} t )$$

where cos(2πf_{LO}t) is the in-phase LO signal 601. The terms inside the square brackets represent the sum of the composite lower sideband 306 and the composite upper sideband 307. The products resulting from this mixing process with the in-phase LO signal 601 are represented by the following expression:

$$\frac{R ( t )}{2} \cdot cos ( 2 π {f}_{RF} t + θ ( t ) ) + ( \begin{matrix}\frac{R ( t )}{4} \cdot cos ( 2 π \cdot ( {f}_{RF} - 2 {f}_{LO} ) \cdot t + θ ( t ) ) + \\ \frac{R ( t )}{4} \cdot cos ( 2 π \cdot ( {f}_{RF} + 2 {f}_{LO} ) \cdot t + θ ( t ) )\end{matrix} ) + ( \begin{matrix}- \frac{S ( t )}{4} \cdot sin ( 2 π \cdot ( {f}_{RF} - 2 {f}_{LO} ) \cdot t + ϕ ( t ) ) + \\ \frac{S ( t )}{4} \cdot sin ( 2 π \cdot ( {f}_{RF} + 2 {f}_{LO} ) \cdot t + ϕ ( t ) )\end{matrix} )$$

After this mixing process, the original first MIMO radio signal 101 has been recovered and has now reappeared at f_{RF} as represented by the term

$$\frac{R ( t )}{2} \cdot cos ( 2 π {f}_{RF} t + θ ( t ) )$$

in the above expression.

The remaining terms in the expression are other mixed products at frequencies f_{RF}−2f_{LO} and f_{RF}+2f_{LO}. These unwanted mixed products are removed by employing a bandpass filter centred around f_{RF}.

Similarly, to recover and restore the second MIMO radio signal in the receiver, the mixing process just described is repeated but with a quadrature-phase LO signal 602 at frequency f_{LO}, which can be represented mathematically by sin(2πf_{LO}t). The mixing process is represented mathematically by the following expression:

$$[ \begin{matrix}\frac{1}{2} \cdot ( \begin{matrix}R ( t ) \cdot cos ( 2 π \cdot ( {f}_{RF} - {f}_{LO} ) \cdot t + θ ( t ) ) + \\ R ( t ) \cdot cos ( 2 π \cdot ( {f}_{RF} + {f}_{LO} ) \cdot t + θ ( t ) )\end{matrix} ) + \\ \frac{1}{2} \cdot ( \begin{matrix}- S ( t ) \cdot sin ( 2 π \cdot ( {f}_{RF} - {f}_{LO} ) \cdot t + ϕ ( t ) ) + \\ S ( t ) \cdot sin ( 2 π \cdot ( {f}_{RF} + {f}_{LO} ) \cdot t + ϕ ( t ) )\end{matrix} )\end{matrix} ] \cdot sin ( 2 π {f}_{LO} t )$$

Expanding the above expression and collecting terms of similar frequencies gives the following

$$\frac{S ( t )}{2} \cdot cos ( 2 π {f}_{RF} t + ϕ ( t ) ) + ( \begin{matrix}- \frac{S ( t )}{4} \cdot cos ( 2 π \cdot ( {f}_{RF} - 2 {f}_{LO} ) \cdot t + ϕ ( t ) ) - \\ \frac{S ( t )}{4} \cdot cos ( 2 π \cdot ( {f}_{RF} + 2 {f}_{LO} ) \cdot t + ϕ ( t ) )\end{matrix} ) + ( \begin{matrix}- \frac{R ( t )}{4} \cdot sin ( 2 π \cdot ( {f}_{RF} - 2 {f}_{LO} ) \cdot t + θ ( t ) ) + \\ \frac{R ( t )}{4} \cdot sin ( 2 π \cdot ( {f}_{RF} + 2 {f}_{LO} ) \cdot t + θ ( t ) )\end{matrix} )$$

The original second MIMO signal 201 has been recovered at frequency f_{RF} and now appears as the first term

$$\frac{S ( t )}{2} \cdot cos ( 2 π {f}_{RF} t + ϕ ( t ) )$$

in the expression above. The rest of the terms represent other mixed products at frequencies f_{RF}−2f_{LO} and f_{RF}+2f_{LO} that can be removed by using a bandpass filter centred around f_{RF}.

An embodiment of the present invention for transporting three MIMO radio signals over fiber is shown in FIG. 7. The first MIMO signal at input 701 is mixed with the in-phase LO signal 708 in mixer 705a. The second MIMO signal at input 703 is mixed with the quadrature-phase LO signal 709 in mixer 705b. The in-phase LO signal 708 and the quadrature-phase LO signal 709 are obtained by passing the local oscillator signal 702 through a 90 degree power splitter 707a. The splitter 707a may be implemented using a 90-degree phase splitter or a 90-degree phase hybrid coupler. Alternatively, the in-phase and quadrature-phase LO signals may be obtained by splitting the LO signal 702 into two equal parts and introducing such a delay into one of the parts that corresponds to a 90-degree phase shift at the LO frequency.

This mixing and any other signal mixing described herein can be performed using analogue multipliers, variable gain amplifiers and/or electrical mixers examples of which include the following: single diode mixers, double balanced diode mixers, triple balanced diode mixers, active bipolar transistor mixers, active field effect transistor mixers or active transistor mixers configured in a Gilbert cell. The two mixed signals are then combined in the power combiner/splitter 711a resulting in a composite lower sideband and a composite upper sideband.

However, due to non-idealities in physical implementation of the mixing process there remains a small component of the original MIMO signals at f_{RF} and other higher-order sidebands generated at f_{RF}−2f_{LO} and f_{RF}+2f_{LO}. These are undesirable for the operation of the present invention. To remove the undesirable higher-order sidebands, an electrical bandpass filter 712a is provided whose pass band is just wide enough to let the two desired sidebands at f_{RF}−f_{LO} and f_{RF}±f_{LO} through and rejecting the higher-order sidebands at f_{RF}−2f_{LO} and f_{rd}+2f_{LO}. The filter 712a is followed by an electrical bandstop filter 713a whose function is to remove the remaining original MIMO signals at f_{RF}. The stop band of the bandstop filter 713a is narrow enough so as not to hinder the two desired sidebands at f_{RF}−f_{LO} and f_{RF}+f_{LO} from passing through. The removal of the residual signal at f_{RF} has the advantage that the original MIMO frequency between the lower and upper sidebands can now be used for insertion and transmission of a third MIMO signal.

The LO source frequency f_{LO} is preferably chosen to be substantially lower than the MIMO radio frequency f_{RF}. For transmission of three MIMO radio signals, there are two criteria for choosing the LO frequency used. Firstly the LO frequency chosen should be high enough so that the lower and upper sidebands generated are sufficiently apart in the frequency domain so that a third non-frequency translated MIMO radio signal can be inserted between them without overlap. Secondly the LO frequency chosen should be low enough so that the lower and upper sidebands generated do not interfere or overlap with other co-transported signals in other frequency bands. Using the IEEE 802.11n WLAN standard operating in the 2.4 GHz ISM band (2.4 GHz to 2.483 GHz) as an example, each MIMO signal occupies 40 MHz channel bandwidth. In order for the frequency translated lower and upper sidebands to be sufficiently apart, an LO frequency of at least 40 MHz, preferably even higher, should be used. However the same optical fiber may commonly carry other radio signals for other wireless services such as the UMTS. The UMTS in the frequency division duplex mode has a nearby downlink frequency band allocated between 2.110 GHz and 2.170 GHz. In order for the two sidebands not to interfere with the UMTS system, the LO frequency should be lower than 230 MHz (The difference between 2.4 GHz and 2.170 GHz). Therefore a 100 MHz LO frequency is a suitable choice in this example. Further criteria affecting the choice of the exact LO frequency are the bandwidth and order of the filters employed.

A third MIMO radio signal from input 704 is combined with the composite lower sideband and the composite upper sideband in power combiner 714a. Since this radio signal from input 704 is at a different frequency from the composite lower and the composite upper sidebands, the combiner 714a can also be implemented with an electrical diplexer or duplexer or any suitable combination of electrical filters.

The resultant signals from 714a are converted to the optical domain in electrical-optical converter 715 (the electrical-optical converter operating using known electrical-optical transmission techniques). Examples of suitable electrical-optical converter 715 include: a directly electrically modulatable laser source; or an external optical intensity modulator in conjunction with a continuous-wave external laser source.

The output of the electrical-optical converter 715 is a modulated optical carrier signal which is launched or coupled into an optical fiber 716. The optical fiber 716 may be of a singlemode type or of a multimode type. In one optional example, an optical power divider or optical filter is used to split the modulated optical signal between two or more optical fibers in order to feed a number of separate receivers.

Once the optical signal has been transmitted over fiber 716 to a receiver at the required destination, the optical signal can be converted back into the electrical domain using an optical-electrical converter 717 (the optical-electrical converter operating using known electrical-optical transmission techniques). The optical-electrical converter 717 can be a photodetector, such as a PIN photodiode, photoconductive photodetector, avalanche photodiode, metal-semiconductor-metal photodiode, Schottky photodiode, bipolar phototransistor, field effect phototransistor or any such photodetector integrated with or directly connected to an electrical amplifier.

To recover and separate the three transmitted MIMO radio signals in the receiver, the output electrical signal from converter 717 is first split into two parts in the combiner/splitter 714b which can be of the same type as combiner/splitter 714a. One of the two parts is sent to the bandpass filter 718a which has the property of removing the composite lower sideband at frequency (f_{RF}−f_{LO}) and the composite upper sideband at frequency (f_{RF}+f_{LO}), letting only the original third MIMO signal at frequency f_{RF} through. Since the third MIMO signal has not undergone any frequency translation, no further frequency mixing is required for this signal and the output from bandpass filter 718a in the receiver is taken as the recovered third MIMO radio signal at output 733.

The other part of the split outputs from combiner/splitter 714b is sent to a bandpass filter 712b which is used to pass the two desired sidebands at f_{RF}−f_{LO} and f_{RF}+f_{LO} as well as any residual signal at f_{RF}, but remove the undesirable higher-order sidebands and other co-transported radio signals in other frequency bands. The bandpass filter 712b is of the same type as 712a. The bandpass filter 712b is followed by a bandstop filter 713b whose function is to remove any residual signal at f_{RF}. The stop band of the bandstop filter 713b is narrow enough so as not to hinder the two desired sidebands at f_{RF}−f_{LO} and f_{RF}+f_{LO} from passing through. The filter 713b is of the same type as filter 713a. The resultant signal after the filtering by filters 712b and 713b is the composite lower sideband and the composite upper sideband from which the first two original MIMO radio signals can be recovered.

The output consisting of the composite lower sideband and the composite upper sideband from the bandstop filter 713b is first split into two equal parts in a power combiner/splitter 711b which is of the same type as combiner/splitter 711a. One part is mixed with the in-phase LO signal 724 in a mixer 705c resulting in the original first MIMO radio signal as well as other undesired higher-order mixed products at f_{RF}−2f_{LO} and f_{RF}+2f_{LO}. The first MIMO radio signal at output 730 is recovered by passing the output from mixer 705c through a bandpass filter 718b which is of the same type as 718a. The other part of the outputs from combiner/splitter 711b is mixed with the quadrature-phase LO signal 725 in a mixer 705d resulting in the original second MIMO radio signal as well as other undesired higher-order mixed products at f_{RF}−2f_{LO} and f_{RF}+2f_{LO}. The second MIMO radio signal at output port 732 is recovered by passing the output from mixer 705d through a bandpass filter 718c which is of the same type as filter 718a.

The in-phase LO signal 724 and the quadrature-phase LO signal 725 in the receiver are obtained in a similar way as in the transmitter by passing a local oscillator signal 731 through a 90 degree power splitter 707b which is of the same type as splitter 707a. Alternatively, the in-phase and quadrature-phase LO signals may be obtained by splitting the LO signal 731 into two equal parts and introducing such a delay into one of the parts that corresponds to a 90-degree phase shift at the LO frequency.

Following the detailed description of the present invention, it can be understood that successful reception and recovery of the original first and second MIMO radio signals in the receiver depends critically on the LO signal in the receiver having the same frequency as the LO signal in the transmitter and having the correct in-phase and quadrature-phase relationship with the received composite lower and upper sidebands. To ensure absolute LO frequency accuracy, the simplest way is to transmit the LO signal used in the transmitter over the same fiber to the receiver where the received LO signal is amplified to a sufficient power level for the recovery mixing process. However, the received and amplified LO signal in the receiver will not necessarily have the correct phase relationship with the composite lower and upper sidebands as they are processed by different electronic components and hence experience different electrical path lengths. Having an inaccurate LO phase in the recovery mixing process would lead to incomplete separation of the two MIMO radio signals. It is therefore important to be able to determine and set the correct LO in-phase and quadrature-phase relationship with the composite lower and upper sideband in the receiver.

There are a number of techniques available to determine and set the correct phase relationship and FIG. 7 will now be used to illustrate one of them. To determine and set the receiver LO phase, the input 701 is driven by a sinusoidal signal of the same frequency as the MIMO radio signal while the input 703 is not used and is properly terminated with a matched load such as a 50 ohm resistive load. The phase of the receiver LO 731 can be adjusted by a phase adjustment means 728a which can be implemented using, for example, a mechanical electrical-signal phase shifter, a digital phase shifter or a voltage controlled analogue varactor diode based electronic phase shifter. The receiver LO phase is adjusted by means of 728a until maximum power level due to the sinusoidal signal is detected at the original output port 730 while minimum power level is detected at the original output port 732. The procedure can be repeated with inputs 701 and 703 swapped. The third MIMO signal at input 704 is irrelevant in this process as it is not frequency translated.

So far the working principles and the implementation of the present invention have been described for transmission of three MIMO radio signals over optical fiber. However, the present invention can also be adopted for transporting four, five and even a greater number of MIMO radio signals over optical fiber.

If five MIMO radio signals are to be transported over optical fiber using the present invention, for example, the embodiment in FIG. 7 can be expanded to that shown in FIG. 8. In FIG. 8, the fourth and the fifth MIMO radio signals present at inputs 801, 802 are mixed with the in-phase and quadrature-phase versions of a second LO signal 803 and their resulting lower and upper sidebands are then combined in the same manner as for the first and second MIMO radio signals from inputs 701 and 703. Following further bandpass and bandstop filterings, all the composite lower and upper sidebands from the first, the second, the fourth and the fifth MIMO radio signals are combined with the non-frequency translated third MIMO radio signal from input 704 in a power combiner 804 in the transmitter before transmission over fiber.

In the embodiment in FIG. 8, the second LO frequency used for mixing with the fourth and fifth MIMO signals in the transmitter is chosen so that the generated lower and upper sidebands do not overlap with those generated by the first and second MIMO signals. Preferably, the second LO frequency used for mixing with the fourth and fifth MIMO signals is twice that for mixing with the first and second MIMO signals.

Following transmission over optical fiber, the fourth and the fifth MIMO signals can be recovered in the same manner as for the first and the second MIMO signals by mixing the corresponding composite lower and upper sidebands with the in-phase and quadrature-phase versions of an LO signal 812 having the same frequency as the second LO in the transmitter. The fourth and the fifth MIMO signals are presented at outputs 810 and 811, respectively.

If an even greater number of MIMO radio signals are to be transported over optical fiber using the present invention, each additional pair of MIMO radio signals can be mixed with the in-phase and quadrature-phase versions of another LO signal having a higher frequency than the previous LO frequencies, for example at successive harmonics of the original LO frequency. If an even number of signals is to be used, then one option is simply to omit the central un-shifted signal at frequency f_{RF} and input 704; the even number of signals are transmitted as pairs of upper and lower sidebands.

1. An apparatus for transporting three or more radio signals of the same frequency over at least one optical fiber, on a single optical carrier, the apparatus comprising:
a first frequency translator arranged to frequency translate a first radio signal to a lower and an upper sideband by mixing the first radio signal with an in-phase version of a first LO signal, and arranged to frequency translate a second radio signal to the same lower and the same upper sideband by mixing the second radio signal with a quadrature-phase version of the same LO signal;
wherein, when the number of radio signals is greater than three, the apparatus comprises a further respective frequency translator for each further pair of signals, arranged to operate in the same way as the first frequency translator to frequency translate each respective pair of radio signals to a different respective pair of lower and upper sidebands around the original radio signal frequency, but using a different LO frequency signal for each said further pair of the radio signals;
wherein, when the total number of radio signals is an odd number, the apparatus is arranged such that the last single radio signal that is not part of any of the radio signal pairs is not frequency translated;
one or more combiners arranged to combine together all resulting pairs of lower and upper sidebands and said last single radio signal, when present, into a single electrical signal;
an optical source arranged to generate an optical carrier signal modulatable by said single electrical signal;
at least one optical fiber arranged to transport the modulated optical carrier signal generated by the optical source;
a photodetection unit arranged to detect the optical signal after transmission over the at least one optical fiber and produce a corresponding received electrical signal;
wherein, when the total number of radio signals is an odd number, the apparatus comprises at least one filter arranged to separate and recover the last single radio signal from the other lower and upper sidebands in the received electrical signal;
first and second mixers arranged to mix the lower and upper sidebands, generated by the first frequency translator, contained in the received electrical signal with the in-phase and quadrature-phase versions of an LO signal having the same LO frequency as used in the first frequency translator to recover the first and second radio signals at their original radio frequency; and
wherein, when the number of radio signals is greater than three, the apparatus comprises further mixers, arranged to operate in the same way as the first and second mixers to recover each other pair of radio signals at the original radio frequency by mixing the respective lower and upper sidebands generated from each respective pair of signals, contained in the received electrical signal, with the in-phase and quadrature-phase versions of a respective LO signal having respective LO frequency as used in the respective further frequency translator.

2. An apparatus according to claim 1, wherein the frequency for the first LO signal for frequency translating the first pair of radio signals is such that the lower and upper sidebands generated are sufficiently apart in the frequency domain so that a non-frequency translated radio signal can be placed between the said lower and upper sidebands in the frequency domain without overlap.

3. An apparatus according to claim 1, wherein the frequency for any subsequent LO signal is selected so as to produce lower and upper sidebands sufficiently far apart that they can accommodate, between them in the frequency domain, any lower and upper sidebands generated earlier and any non-frequency translated radio signal, without overlap.

4. An apparatus according to claim 1, wherein the frequency for any LO signal is selected so as to produce such lower and upper sidebands that in the frequency domain will not interfere or overlap with other lower and upper sidebands generated using other respective LO frequencies, and will not interfere or overlap with other co-transported signals in other frequency bands.

5. An apparatus according to claim 1, wherein the mixers for recovering the radio signals are arranged to receive LO signals generated by one or more independent phased-locked LOs or derived and sent over the optical fiber or fibers from one or each original LO signal used by the frequency translators.

6. An apparatus according to claim 1, further comprising at least one phase-shifter arranged to adjust the phase of the or each LO signal used for recovering the radio signals.

7. An apparatus according to claim 1, wherein the radio signals of the same frequency are MIMO radio signals.

8. A method for transporting three or more radio signals of the same frequency over at least one optical fiber, on a single optical carrier, the method comprising:
frequency translating a first radio signal to a lower and an upper sideband by mixing the first radio signal with an in-phase version of an LO signal, and frequency translating a second radio signal to the same lower and the same upper sideband by mixing the second radio signal with a quadrature-phase version of the same LO signal, with these two resulting pairs of lower and upper sidebands subsequently combined together;
wherein, when the number of radio signals is greater than three, frequency translating each further pair of radio signals, in the same way as the first and second radio signals, to a different respective pair of lower and upper sidebands around the original radio signal frequency, using a different LO frequency signal for each further pair of radio signals;
wherein, when the total number of radio signals is an odd number, the last single radio signal that is not part of any of the radio signal pairs is not frequency translated;
combining together all resulting pairs of lower and upper sidebands and said last single radio signal, when present, into a single electrical signal;
modulating an optical carrier signal using said single electrical signal;
transporting the modulated optical carrier signal over at least one optical fiber;
detecting the optical signal after transmission over the at least one optical fiber and producing a corresponding received electrical signal;
wherein, when the total number of radio signals is an odd number, separating and recovering the last single radio signal from the lower and upper sidebands in the received electrical signal by filtering;
recovering the first and second radio signals at their original radio frequency by mixing the lower and upper sidebands, generated by the first frequency translating step, contained in the received electrical signal with the in-phase and quadrature-phase versions of an LO signal having the same LO frequency as used in the first frequency translating step; and
wherein, when the number of radio signals is greater than three, recovering each other pair of radio signals at the original radio frequency by mixing the respective lower and upper sidebands generated from each respective pair of signals, contained in the received electrical signal, with the in-phase and quadrature-phase versions of a respective LO signal having respective LO frequency as used in the respective frequency translation.

9. A method according to claim 8, wherein the frequency for the first LO signal for frequency translating the first pair of radio signals is selected such that the lower and upper sidebands generated are sufficiently apart in the frequency domain so that a non-frequency translated radio signal can be placed between the said lower and upper sidebands in the frequency domain without overlap.

10. A method according to claim 8, wherein the frequency for any subsequent LO signal is selected so as to produce lower and upper sidebands sufficiently far apart that they can accommodate, between them in the frequency domain, any lower and upper sidebands generated earlier and any non-frequency translated radio signal, without overlap.

11. A method according to claim 8, comprising selecting the frequency for any LO signal so that it is below an upper limit so as to produce such lower and upper sidebands that in the frequency domain will not interfere or overlap with other lower and upper sidebands generated using other respective LO frequencies, and will not interfere or overlap with other co-transported signals in other frequency bands.

12. A method according to claim 8, wherein the LO signals for recovering the radio signals are generated by one or more independent phased-locked LOs or are derived and sent over the optical fiber or fibers from one or each original LO signal used for the frequency translating.

13. A method according to claim 8, wherein the relative phase relationships between the LO signals used for frequency translations and the LO signals used for recovery of the frequency translated radio signals are determined and set as follows:
instead of sending a first and a second radio signal of any such signal pair or pairs over the or each optical fiber, sending a sinusoidal signal of the same frequency as the carrier frequency of the radio signals in place of the said first radio signal and sending nothing in place of the said second radio signal;
recovering and measuring the power of the received sinusoidal signal at a location where the said first radio signal is normally recovered;
measuring any signal power at a location where the said second radio signal is normally recovered; and
adjusting the phase of the corresponding LO signal used for recovering the first and second radio signals in order to maximise the power of the received sinusoidal signal at a location where the first radio signal is normally recovered and to minimise any received signal power at a location where the second radio signal is normally recovered.

14. A method according to claim 13, wherein the adjusting of the phase of the LO signal is performed using one or more of the following in any combination: an automatic electronic means; a digital phase shifter; a voltage controlled analogue varactor diode based electronic phase shifter; a mechanical electrical-signal phase shifter; a mechanical electrical-signal delay line.

15. A method according to claim 8, wherein the radio signals of the same frequency are MIMO radio signals.
